(19) United States
(12) Patent Application Publication
(10) Pub. No.: US 2016/0285087 A1
(43) Pub. Date: Sep. 29, 2016

(54) NICKEL-METAL HYDRIDE BATTERY

(71) Applicant: PRIMEARTH EV ENERGY CO., LTD., Kosai-shi (JP)

(72) Inventors: Suguru MURAKI, Kosai-shi (JP); Yuki SAKITO, Toyohashi-shi (JP); Hiroyuki SAKAMOTO, Toyohashi-shi (JP)

(21) Appl. No.: 14/836,932

(22) Filed: Aug. 26, 2015

(30) Foreign Application Priority Data
Mar. 27, 2015 (JP) 2015-065832

(51) Int. Cl. H01M 4/38; H01M 2/02; H01M 10/30

(52) U.S. Cl. CPC H01M 4/383; H01M 10/30; H01M 2/0257; H01M 2/026; H01M 2/0262; H01M 2220/20; H01M 2220/30

(57) ABSTRACT

A nickel-metal hydride battery includes a positive electrode and a negative electrode, which includes a hydrogen-absorbing alloy that includes first and second hydrogen-absorbing alloys. The negative electrode has a capacitance including a negative electrode main body capacitance, which corresponds to a capacitance of the positive electrode, and a discharge reserve, which is a capacitance added to the negative electrode main body capacitance. The first hydrogen-absorbing alloy has a lower hydrogen equilibrium dissociation pressure than the second hydrogen-absorbing alloy and a higher pulverization capacity, which indicates how easy pulverization occurs, than the second hydrogen-absorbing alloy.

### CROSS-REFERENCE TO RELATED APPLICATIONS

This application is based upon and claims the benefit of priority from prior Japanese Patent Application No. 2015-065832, filed on Mar. 27, 2015, the entire contents of which are incorporated herein by reference.

### BACKGROUND ART

The present invention relates to a nickel-metal hydride battery.

A nickel-metal hydride battery has a high energy density and high reliability and is thus used as a power supply for a portable device or as a power supply for an electric vehicle or a hybrid vehicle. The nickel-metal hydride battery includes a positive electrode, the main component of which is nickel hydroxide, a negative electrode, the main component of which is a hydrogen-absorbing alloy, and an alkaline electrolyte.

When charging and discharging the nickel-metal hydride battery, the hydrogen-absorbing alloy adorbs and releases hydrogen. When repetitively absorbing and releasing hydrogen, the hydrogen-absorbing alloy expands and contracts. This pulverizes the hydrogen-absorbing alloy. As the surface area of the pulverized hydrogen-absorbing alloy increases, corrosion advances in the hydrogen-absorbing alloy due to the alkaline electrolyte. This shortens the life of the hydrogen-absorbing alloy. Thus, studies have been conducted in the prior art to improve the corrosion resistance of the alloy adsorption alloy against the alkaline electrolyte and hinder the pulverization of the hydrogen-absorbing alloy (for example, refer to Japanese Patent Publication No. 5-156382).

### SUMMARY OF THE INVENTION

On the other hand, pulverization of the hydrogen-absorbing alloy increases the surface area of the hydrogen-absorbing alloy, which contains metal (e.g., nickel) having high conductivity. This increases the area of the metal exposed from the hydrogen-absorbing alloy. The exposed metal acts as a reaction catalyst. When a large amount of highly conductive metal is exposed, the internal resistance decreases in the negative electrode. This improves the power output characteristics of the nickel-metal hydride battery.

Accordingly, in the prior art, there is a tradeoff of one for the other with the pulverization of the hydrogen-absorbing alloy and the improvement of the corrosion resistance.

One aspect of the present invention is a nickel-metal hydride battery including a positive electrode and a negative electrode, which includes a hydrogen-absorbing alloy that includes a first hydrogen-absorbing alloy and a second hydrogen-absorbing alloy. The negative electrode has a capacitance including a negative electrode main body capacitance, which corresponds to a capacitance of the positive electrode, and a discharge reserve, which is a capacitance added to the negative electrode main body capacitance. The first hydrogen-absorbing alloy has a lower hydrogen equilibrium dissociation pressure than the second hydrogen-absorbing alloy and a higher pulverization capacity, which indicates how easy pulverization occurs, than the second hydrogen-absorbing alloy. The positive electrode has a state of charge with a lower limit value of 0% or greater. A ratio of the first hydrogen-absorbing alloy relative to the entire hydrogen-absorbing alloy is less than a ratio obtained by adding a ratio of the discharge reserve relative to the capacitance of the negative electrode and a ratio of a capacitance corresponding to the lower limit value of the state of charge of the positive electrode in the negative electrode main body capacitance relative to the capacitance of the negative electrode.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram showing the structure of one embodiment of a nickel-metal hydride battery;

FIG. 2 is a cross-sectional view showing one end of an electrode plate group in the nickel-metal hydride battery;

FIG. 3 is a conceptual diagram showing the balance of the positive electrode capacitance and the negative electrode capacitance in the nickel metal-hydride battery;

FIG. 4 is a graph showing the magnetic susceptibility of a first hydrogen-absorbing alloy and the magnetic susceptibility of a second hydrogen-absorbing alloy;

FIG. 5 is a graph showing pressure-composition-temperature curves of the first hydrogen-absorbing alloy, the second hydrogen-absorbing alloy, and a mixture of the first and second hydrogen-absorbing alloys.

FIGS. 6A and 6B are conceptual diagrams showing the capacitance of the first hydrogen-absorbing alloy relative to the negative electrode capacitance in the first embodiment, in which FIG. 6A shows a condition in which the capacitance of the first hydrogen-absorbing alloy is greater than or equal to a discharge reserve, and FIG. 6B shows a condition in which the capacitance of the first hydrogen-absorbing alloy is less than the discharge reserve;

FIG. 7 is a graph showing the charging characteristic and discharging characteristics of a negative electrode that includes the first hydrogen-absorbing alloy and the second hydrogen-absorbing alloy and the charging characteristic and discharging characteristics of a negative electrode that includes the second hydrogen-absorbing alloy; and

FIG. 8 is a table showing the evaluation results of an example and a comparative example.

### EMBODIMENTS OF THE INVENTION

One embodiment of a nickel-metal hydride battery will now be described.

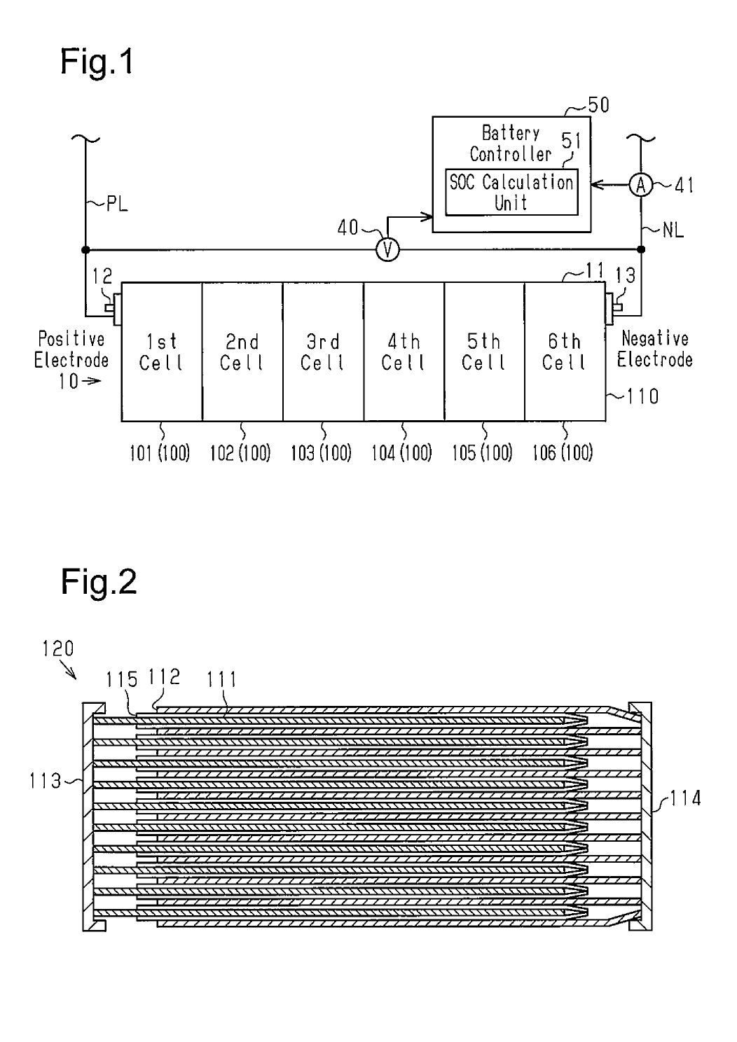

With reference to FIG. 1, a battery 10, which is installed in a hybrid vehicle, will now be described with reference to FIG. 1. In the present embodiment, the battery 10, which serves as a power supply for an electric motor, is electrically connected to the motor. The battery 10 is also electrically connected to a generator and charged by the power generated when the generator is driven. The hybrid vehicle that includes the battery 10 may be a plugin hybrid vehicle capable of charging the battery 10 with power transmitted from an external power supply. In this case, the battery 10 is connected to an on-board charger that is connected to an external power supply.

The battery 10 is a battery assembly including battery modules 11 that are electrically connected in series or in parallel. Each battery module 11 includes battery cells 100. Each battery cell 100 includes a negative electrode, which contains a hydrogen-absorbing alloy, and a positive electrode, which contains nickel hydroxide.

Each battery module 11 includes a resin case 110 that accommodates six battery containers. The battery containers respectively correspond to first to sixth cells 101 to 106, which are the battery cells 100. Each battery module 11 includes the first to sixth cells 101 to 106, which are electrically connected in series, a positive electrode terminal 12, and a negative electrode terminal 13. The positive and negative electrode terminals 12 and 13 are used as input-output terminals of the first to sixth cells 101 to 106 during charging and discharging. The positive electrode terminal 12 is connected to the motor by a positive line PL. The negative electrode terminal 13 is connected to the motor by a negative line NL.

A voltmeter 40 is electrically connected between the positive electrode terminal 12 and the negative electrode terminal 13 to measure the potential between the two terminals. Further, an ammeter 41 is electrically connected in series to each battery module 11 to measure the current input and output through the negative line NL. The voltmeter 40 provides a battery controller 50 with a signal indicating the measured potential. The ammeter 41 provides the battery controller 50 with a signal indicating the measured current.

In FIG. 1, a plurality of the voltmeters 40 are respectively connected to the plurality of battery modules 11. Instead, a single voltmeter 40 may be connected to the plurality of battery modules 11, and the battery controller 50 may obtain the voltage of each battery module 11 from the potential measured by the single voltmeter 40. In the same manner, a single ammeter 41 may be connected to the plurality of battery modules 11, and the battery controller 50 may obtain the current of each battery module 11 from the current measured by the single ammeter 41.

The battery controller 50 includes a computer, which has a computation unit and a memory unit, and performs various processes by executing computations with the computation unit based on programs stored in the memory unit. Further, the battery controller 50 includes an SOC calculation unit 51. The SOC calculation unit 51 calculates the state of charge (SOC), which is the charging rate of the battery 10, from the potential based on the signal received from the voltmeter 40 and the current based on the signal received from the ammeter 41.

The charging and discharging of the battery 10 is controlled within an SOC control range, which is set as a control range of the hybrid vehicle. The battery controller 50 provides a motor controller (not shown), which controls the motor, with a signal corresponding to the SOC calculated by the SOC calculation unit 51. The motor controller controls the charging and discharging of the battery 10 based on the signal received from the battery controller 50. For example, in a hybrid vehicle including a generator that uses the engine output to generate power, the engine is driven so that the SOC of the battery 10 does not become less than the lower limit of the SOC control range, and the motor is driven so that the SOC of the battery 10 does not exceed the upper limit of the SOC control range.

As shown in FIG. 2, the battery cell 100 includes an electrode plate group 120, an electrolyte (not shown), a positive electrode collector plate 113, and a negative electrode collector plate 114. The electrode plate group 120 includes positive electrode plates 111, negative electrode plates 112, and separators 115. The positive electrode plates 111 and the negative electrode plates 112 are alternately stacked with the separators 115 arranged in between. The ends of the positive electrodes 111 are bonded to the positive electrode collector plate 113 by undergoing a bonding process such as welding. The ends of the negative electrode plates 112 are bonded to the negative electrode collector plate 114 by undergoing a bonding process such as welding.

Each positive electrode plate 111 includes a base material, which is formed by a three-dimensional porous body, and a positive electrode compound, which is supported by the base material. Preferably, the base material is formed from a foam base material. For example, foam nickel may be used as the foam metal. The base material has the functions of a carrier, which supports the positive electrode compound, and the functions of a collector. The positive electrode compound includes a conductive agent and a positive electrode active material, the main component of which is nickel hydroxide.

Each negative electrode plate 112 includes a core and a negative electrode compound, which is carried by the core. The negative electrode compound contains a hydrogen-absorbing alloy. The hydrogen-absorbing alloy is an alloy or an intermetallic compound that absorbs and releases hydrogen in a reversible manner under the working temperature and working pressure. Although the type of the hydrogen-absorbing alloy is not particularly limited, the hydrogen-absorbing alloy may be, for example, mischmetal, which is an alloy or rare earth elements; a calcium hydrogen-absorbing alloy, the main components of which are calcium (Ca) and another transition metal; a rare earth element hydrogen-absorbing alloy, the main components of which are a rare earth elements such as lanthanum (La) or cerium (Ce) and another transition metal; a magnesium hydrogen-absorbing alloy, the main component of which is magnesium; a titanium hydrogen-absorbing alloy, the main component of which is titanium and another transition metal; a zirconium hydrogen-absorbing alloy, the main component of which is zirconium and another transition metal; or a Laves phase hydrogen-absorbing alloy, which has a Laves phase structure. Further, when “A” represents an element having a high affinity to hydrogen and “B” represents an element having a low affinity to hydrogen, the composition of the hydrogen-absorbing alloy may be AB₅ hydrogen-absorbing alloy that is of an AB₅ type, an AB₂ hydrogen-absorbing alloy that is of an AB₂ type, an AB type hydrogen-absorbing alloy that is of an AB type, or another type of hydrogen-absorbing alloy.

Among metals that may be used to form the hydrogen-absorbing alloy, the hydrogen-absorbing alloy contains a metal having a particularly high conductivity. Nickel (Ni) is such a metal having a particularly high conductivity. Such a hydrogen-absorbing alloy is expressed by, for example, MmNixMy (where x and y are real numbers).

In addition to the hydrogen-absorbing alloy, the negative electrode compound includes a thickening agent, such as carboxymethyl cellulose, and a binding agent such as styrene-butadiene copolymer. A plurality of the negative electrode compound elements are mixed to form a product, which is a paste. The product is applied to a core, which is a punching metal or the like. Then, the punching metal is dried, rolled, and cut. This manufactures the negative electrode plate 112.

Half-reaction expressions (1) and (2), which are shown below, indicate the discharging reaction of the positive electrode and the negative electrode in the nickel hydride battery. The charging reaction and the discharging reaction advance in opposite directions. In the negative electrode, the hydrogen-absorbing alloy is dehydrogenated during discharging, and the hydrogen-absorbing alloy is hydrogenated during charging.

Positive Electrode

NiOOH+H₂O+e⁻→Ni(OH)₂+OH⁻ (1)

Negative Electrode

MH+OH⁻→M+H₂O+e⁻ (2)

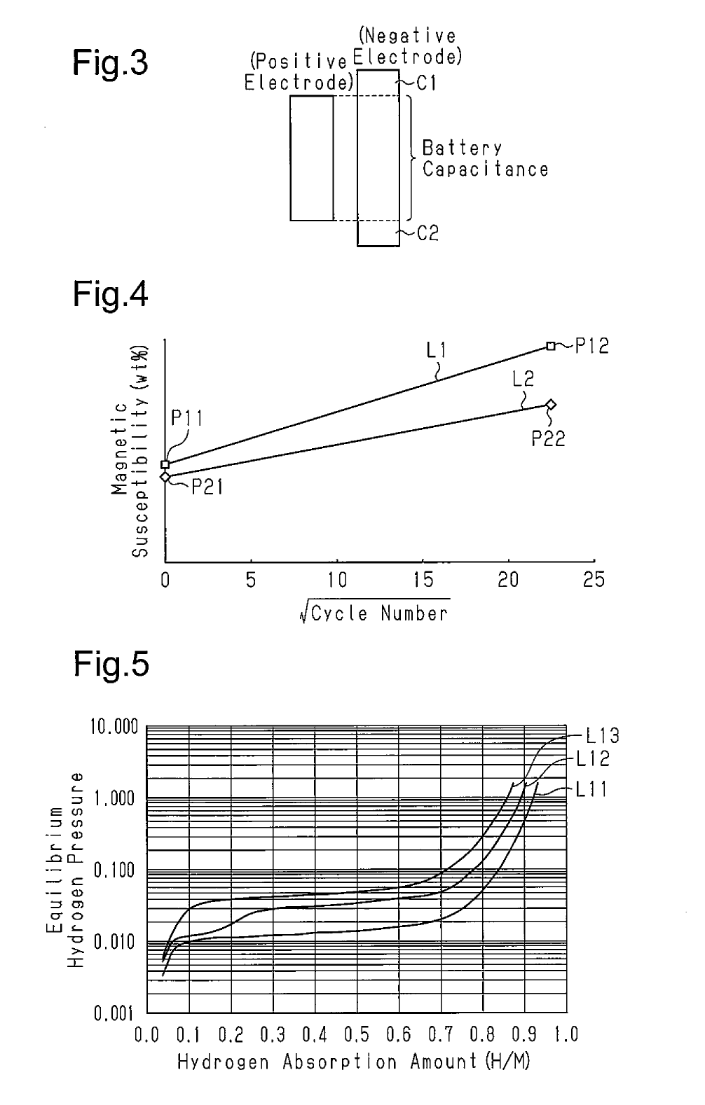

As shown in FIG. 3, in the battery cell 100, the negative electrode capacitance is greater than the positive electrode capacitance, and the battery capacitance of the battery cell 100 is restricted by the positive electrode capacitance. That is, the battery cell 100 has a positive electrode-restricted structure. In an initial state such as during shipment, the negative electrode capacitance includes a charge reserve C1, which is a reserve charge capacitance when the positive electrode is fully charged, and a discharge reserve C2, which is a reserve discharge capacitance when the SOC of the positive electrode reaches 0%. The negative electrode capacitance includes the charge reserve C1, the discharge reserve C2, and a negative electrode main body capacitance C5. In the initial state, the positive electrode capacitance and the negative electrode capacitance of the battery cells 100 are balanced in each battery module 11. The positive electrode is fully charged when the positive electrode material of the battery cell 100 no longer has non-charged portions. In this case, the SOC of the positive electrode is 100%. When the SOC of the positive electrode reaches 0%, that is, when the positive electrode material of the battery cell 100 no longer has charged portions, the SOC of the battery cell 100 is 0%. When the SOC of the positive electrode reaches 100%, the SOC of the battery cell 100 is 100%. By providing the negative electrode capacitance with the charge reserve C1, the generation of hydrogen from the negative electrode may be reduced during over-charging. Further, by providing the negative electrode capacitance with the discharge reserve C2, the generation of oxygen from the negative electrode may be reduced during over-discharging.

The hydrogen-absorbing alloy in the negative electrode will now be described in detail. The hydrogen-absorbing alloy of the present embodiment is a mixture of a first hydrogen-absorbing alloy and a second hydrogen-absorbing alloy. The first hydrogen-absorbing alloy has a low hydrogen equilibrium dissociation pressure and a high pulverization capacity. The second hydrogen-absorbing alloy has a high hydrogen equilibrium dissociation pressure and a low pulverization capacity.

The hydrogen equilibrium dissociation pressure and pulverization capacity will now be described. Generally, when a battery is charged, a hydrogen-absorbing alloy is hydrogenated by drawing and absorbing hydrogen atoms into metal gratings. When the battery is discharged, the hydrogen-absorbing alloy is dehydrogenated by releasing the hydrogen atoms from the metal gratings. Repetition of the hydrogenation and dehydrogenation pulverizes the alloy into powder. As the repeated number of times of hydrogenation and dehydrogenation increases, pulverization advances in the hydrogen-absorbing alloy and the grains of the hydrogen-absorbing alloy become finer. The degree in which pulverization advances differs between different types of alloys. The degree in which pulverization advances is referred to as the pulverization capacity.

Pulverization of a hydrogen-absorbing alloy increases the area of contact with the alkaline electrolyte. As the area of contact with the electrolyte increases, the hydrogen-absorbing alloy is apt to being corroded. Further, pulverization of the hydrogen-absorbing alloy results in the exposure of a large amount of highly conductive metal such as nickel. In this manner, an increase in the exposed area of the highly conductive metal lowers the internal resistance of the negative electrode compound and increases the output of the battery cell 100.

Pulverization may be evaluated after charging and discharging is repeated a predetermined number of times based on the surface area of the hydrogen-absorbing alloy or the average grain diameter. Further, pulverization may be evaluated after charging and discharging is repeated a predetermined number of times based on the magnetic susceptibility of the hydrogen-absorbing alloy. A larger magnetic susceptibility increases the pulverization degree of the hydrogen-absorbing alloy. A vibrating sample magnetometer (VSM) may be used to measure the magnetic susceptibility.

FIG. 4 shows a magnetic susceptibility curve L1, which shows changes in the magnetic susceptibility of the first hydrogen-absorbing alloy resulting from charging and discharging, and a magnetic susceptibility curve L2, which shows changes in the magnetic susceptibility of the second hydrogen-absorbing alloy resulting from charging and discharging. When the hydrogen-absorbing alloy forming a battery cell includes only the first hydrogen-absorbing alloy, the magnetic susceptibility of the first hydrogen-absorbing alloy is as indicated in the magnetic susceptibility curve L1. When the hydrogen-absorbing alloy forming a battery cell includes only the second hydrogen-absorbing alloy, the magnetic susceptibility of the first hydrogen-absorbing alloy is as indicated in the magnetic susceptibility curve L2.

In the magnetic susceptibility curves L1 and L2, points P11 and P21 indicate the magnetic susceptibility subsequent to an initial activation process in which charging of the positive electrode performed from an SOC of “0%” to “100%” and discharging of the positive electrode performed until reaching an SOC of “0%” are repeated ten times. Points P12 and P22 indicate the magnetic susceptibility of the hydrogen-absorbing alloy after conducting 500 cycles of an endurance test subsequent to the initial activation process. In the endurance test, in a single cycle, the positive electrode is charged and discharged in an SOC range from 20% or greater to 80% or less. The magnetic susceptibility curve L1 is a straight line extending through the points P11 and P12. The magnetic susceptibility curve L2 is a straight line extending through the points P21 and P22. The magnetic susceptibility curves L1 and L2 show that pulverization, which results from charging and discharging, advances more quickly in the first hydrogen-absorbing alloy than in the second hydrogen-absorbing alloy.

The hydrogen equilibrium dissociation pressure will now be described. The hydrogen adsorption characteristics differ in accordance with the type of hydrogen-absorbing alloy. The hydrogen adsorption characteristics includes the hydrogen adsorption amount (H/M), which is the ratio of the hydrogen amount included in a certain amount of alloy, the hysteresis set for the adsorption pressure and release pressure of the hydrogen, and the hydrogen equilibrium dissociation pressure, which is the hydrogen pressure when the hydrogenation reaction and the dehydrogenation reaction are in equilibrium.

The hydrogen equilibrium dissociation pressure is calculated from a pressure-composition-temperature (PCT) curve, which is in compliance with, for example, JISH7201. The PCT curve is obtained by absorbing hydrogen in the hydrogen-absorbing alloy. When generating the PCT curve, a pre-processed hydrogen-absorbing alloy is arranged in a measurement container. The measurement container undergoes vacuum deaeration, and the hydrogen-absorbing alloy is dehydrogenated. Then, hydrogen gas is drawn into the measurement container until the pressure of the measurement container reaches a predetermined pressure. When the inside of the measurement container is in equilibrium, the pressure of the hydrogen gas is measured. The measurement is repeated a predetermined number of times, while changing the amount of drawn in hydrogen gas. The measured pressure is applied to a predetermined equation to obtain the PCT curve. In the PCT curve, the flat region corresponds to the hydrogen equilibrium dissociation pressure (plateau pressure). The hydrogen equilibrium dissociation pressure may be obtained from the PCT curve when hydrogen is released from the hydrogen adsorption pressure.

When the hydrogen equilibrium dissociation pressure is measured under fixed conditions, as the hydrogen equilibrium dissociation pressure increases, the negative electrode potential that starts hydrogenation and dehydrogenation becomes closer to the negative electrode potential of the fully charged state. Thus, although the battery 10 is not controlled in such a manner during actual use, when the negative electrode is charged from an SOC of “0%” to “100%,” the hydrogenation reaction of the first hydrogen-absorbing alloy first starts and advances before the hydrogenation reaction of the second hydrogen-absorbing alloy starts. Further, when the negative electrode is discharged from an SOC of “100%” to “0%,” the dehydrogenation reaction of the second hydrogen-absorbing alloy first starts and advances before the hydrogenation reaction of the first hydrogen-absorbing alloy starts.

FIG. 5 shows PCT curves of the first hydrogen-absorbing alloy, the second hydrogen-absorbing alloy, and the mixture of the first and second hydrogen-absorbing alloys. The PCT curves show the hydrogen adsorption amount and the hydrogen pressure when the hydrogen-absorbing alloy absorbs hydrogen and is in equilibrium. The vertical axis represents the logarithm of the equilibrium hydrogen pressure, which is the pressure of hydrogen when in equilibrium, and the horizontal axis represents the hydrogen adsorption amount (H/M). Curve L11 is the PCT curve of the first hydrogen adsorption amount, and curve L13 is the PCT curve of the second hydrogen-absorbing alloy. Curve L12 is a PCT curve obtained when mixing the first and second hydrogen-absorbing alloys at a predetermined ratio. The equilibrium hydrogen pressure of the mixture of the first and second hydrogen-absorbing alloys is close to the equilibrium hydrogen pressure of the first adsorption alloy when the hydrogen adsorption amount is small and close to the equilibrium hydrogen pressure of the second adsorption alloy when the hydrogen adsorption amount is large. It may be understood from the behavior of the negative electrode potential when mixing the first and second hydrogen-absorbing alloys that hydrogenation and dehydrogenation are caused by different hydrogen-absorbing alloys.

Preferably, the difference in the hydrogen equilibrium dissociation pressure between the first hydrogen-absorbing alloy and the hydrogen equilibrium dissociation pressure of the second hydrogen-absorbing alloy is greater than or equal to 0.01 MPa at the hydrogen dissociation pressure corresponding to 45° C. If the difference is greater than or equal to 0.01 MPa, a proper potential difference is produced between the potential at the first hydrogen-absorbing alloy and the potential at the second hydrogen-absorbing alloy when charging starts. Further, a proper potential difference is produced between the potential at the first hydrogen-absorbing alloy and the potential at the second hydrogen-absorbing alloy when discharging starts. This hinders the starting of the dehydrogenation of the first hydrogen-absorbing alloy during the dehydrogenation of the second hydrogen-absorbing alloy resulting from discharging. In one example, the hydrogen equilibrium dissociation pressure of the first hydrogen-absorbing alloy at 45° C. is greater than or equal to 0.005 MPa and, preferably, greater than or equal to 0.005 MPa and less than or equal to 0.03 MPa. Further, the hydrogen equilibrium dissociation pressure of the second hydrogen-absorbing alloy at 45° C. is greater than or equal to 0.03 MPa and, preferably, greater than or equal to 0.03 MPa and less than or equal to 0.06 MPa. However, the hydrogen equilibrium dissociation pressure of the first hydrogen-absorbing alloy and the hydrogen equilibrium dissociation pressure of the second hydrogen-absorbing alloy are not limited to these values.

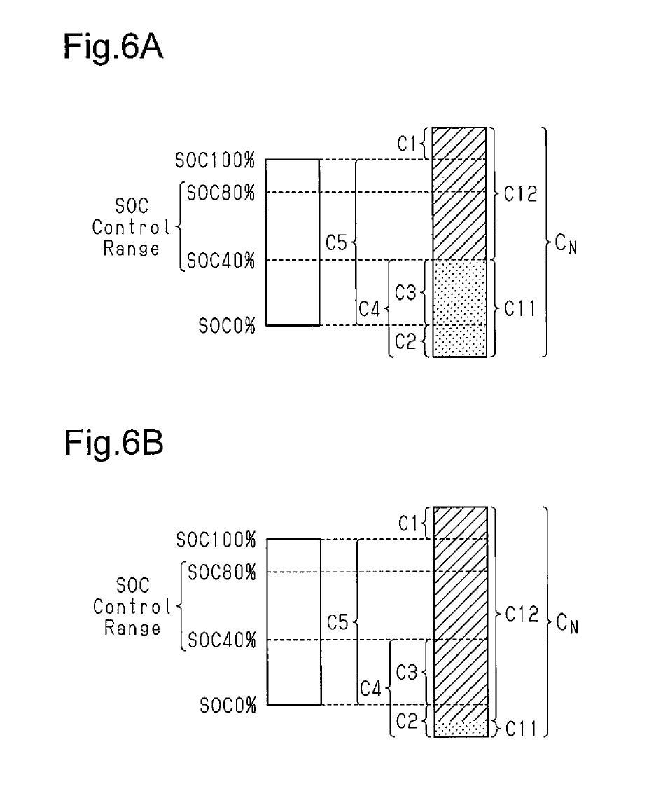

With reference to FIGS. 6A and 6B, the mixture ratio of the first and second hydrogen adsorption amounts will now be described. As shown in FIG. 6A, the controller of the motor controls the SOC of the battery 10 within an SOC control range having a lower limit value of “40%” and an upper limit value of “80%.” When the battery 10 is controlled so that the SOC of the battery 10 is within the SOC control range, the positive electrode active material and the negative electrode active material corresponding to capacitance C3 for the SOC of “0%” or greater to less than “40%” are not involved with the charging reaction and the discharging reaction. Hereafter, capacitance C3 will be referred to as the unused capacitance C3. Although this is theoretically unused capacitance, when a capacitance imbalance occurs between the battery cells 100 in each battery module 11, the positive and negative electrode active materials corresponding to the unused capacitance C3 may be involved with the charging reaction and the discharging reaction.

Further, as long as the SOC of the battery 10 is at least controlled to be “0%” or greater, the negative active material corresponding to the discharge reserve C2 in the negative electrode capacitance C_{N} is not involved with the charging reaction and the discharging reaction. That is, as long as charging and discharging are controlled so that the SOC of the battery 10 is within the SOC control range, the positive and negative electrode active materials of the unused capacitance C3 and the negative electrode active material corresponding to the discharge reserve C2 are not involved with the charging reaction and the discharging reaction.

In the negative electrode capacitance C_{N}, capacitance C11 of the first hydrogen-absorbing alloy is less than capacitance C4, which is the sum of the discharge reserve C2 and the unused capacitance C3. The ratio of the first hydrogen-absorbing alloy relative to the entire hydrogen-absorbing alloy is less than a ratio (C4/C_{N}), which is obtained by adding the ratio of the discharge reserve C2 relative to the negative electrode capacitance C_{N} (C2/C_{N}) and the ratio of the capacitance corresponding to less than the SOC lower limit value, or the unused capacitance C3, relative to the negative electrode capacitance C_{N} (C3/C_{N}). In the hydrogen-absorbing alloy, the ratio (C4/C_{N}) obtained through such a calculation corresponds to the ratio of the hydrogen-absorbing alloy that is not directly involved with the charging reaction and the discharging reaction. When the battery 10 is discharged from an SOC of 100%, the second hydrogen-absorbing alloy becomes involved with the discharging reaction before the first hydrogen-absorbing alloy. Thus, in FIGS. 6A and 6B, the capacitance C12 of the second hydrogen-absorbing alloy is located at the high SOC side, and the capacitance C11 of the first hydrogen-absorbing alloy is located at the low SOC side.

Equation (1), which is shown below, expresses the negative electrode capacitance γ per unit mass where “α(Ah/g)” represents the capacitance of the first hydrogen-absorbing alloy per unit mass, “β(Ah/g)” represents the capacitance of the second hydrogen-absorbing alloy per unit mass, “X” represents the ratio of the first hydrogen-absorbing alloy relative to the mass of the entire hydrogen-absorbing alloy, and “γ(Ah/g)” represents the negative electrode capacitance per unit mass. The negative electrode capacitance “γ” is obtained by dividing the negative electrode capacitance C_{N} by the mass of the negative electrode. The ratio “X” is larger than 0 and smaller than 1. From equation (1), ratio “X” is expressed as shown in equation (2).

γ=α(1−X)+βX (1)

X=(γ−α)/(β−α) (2)

FIG. 6A shows a condition in which the ratio of the first hydrogen-absorbing alloy relative to the entire hydrogen-absorbing alloy is the maximum. That is, the capacitance C11 of the second hydrogen-absorbing alloy is the maximum value of a range that is less than the capacitance (C4), which is obtained by adding the discharge reserve C2 and the unused capacitance C3.

FIG. 6B shows a condition in which the ratio of the first hydrogen-absorbing alloy relative to the entire hydrogen-absorbing alloy is less than the ratio (C2/C_{N}) of the discharge reserve C2 relative to the negative electrode capacitance C_{N}.

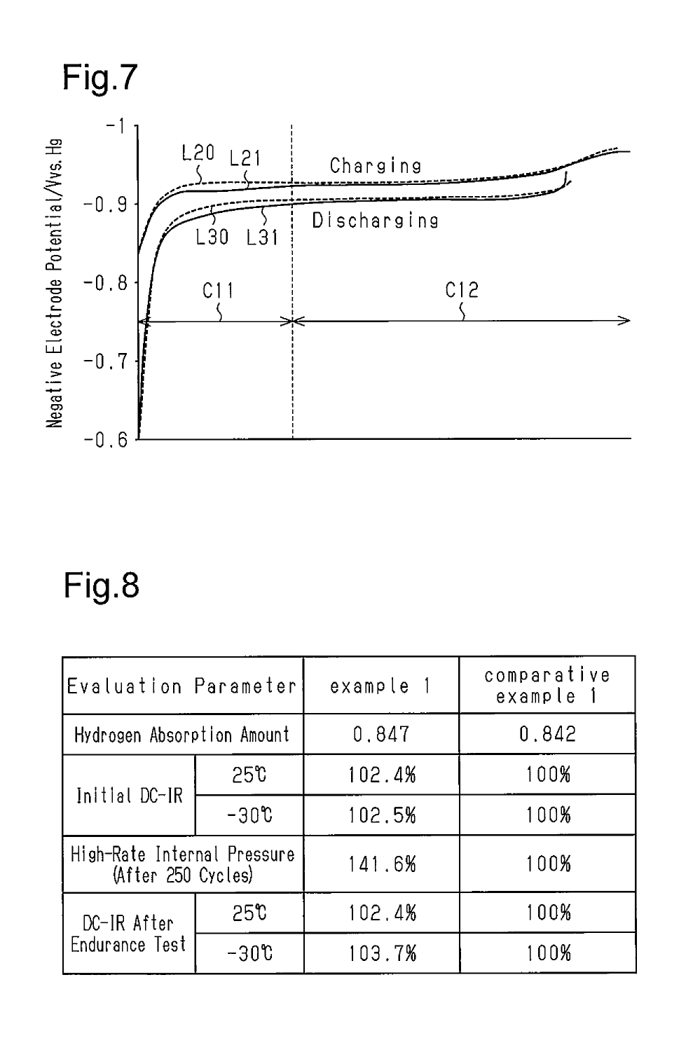

With reference to FIG. 7, the charging characteristics and the discharge characteristics of the negative electrode, which is formed by the first hydrogen-absorbing alloy and the second hydrogen-absorbing alloy, will now be described.

The graph of FIG. 7 shows the charging curve and the discharging curve that indicate changes in the negative electrode potential relative to the negative electrode SOC. The negative electrode potential is the potential at a reference electrode inserted into a battery cell 100 and measured when charging and discharging the battery cell 100. The horizontal axis of the graph represents the negative electrode SOC, and the vertical axis of the graph represents the negative electrode potential. The difference between the hydrogen equilibrium dissociation pressure of the first hydrogen-absorbing alloy and the hydrogen equilibrium dissociation pressure of the second hydrogen-absorbing alloy is greater than or equal to 0.01 MPa at the hydrogen dissociation pressure corresponding to 45° C.

Among the two upper charging curves shown in FIG. 7, the charging curve L21 shown by the solid line is based on a negative electrode that uses the hydrogen-absorbing alloy of the present embodiment, and the negative electrode charging curve L20 shown by the broken line is based on a negative electrode using only the second hydrogen-absorbing alloy. The vertical axis represents the negative electrode potential, and the potential decreases (absolute value increases) at higher positions in the vertical axis. The charging curves L20 and L21 indicate the negative electrode potential measured when starting charging from the negative electrode SOC of “0%.” When the negative electrode SOC is low, under the condition that the SOC is the same, the potential at the negative electrode of the present embodiment (charging curve L21) is higher (has a smaller absolute value) than the potential at the negative electrode formed by only the second hydrogen-absorbing alloy (charging curve L20). That is, in the initial charging state of the negative electrode that starts at the SOC of “0%,” the hydrogenation of the first hydrogen-absorbing alloy advances first. When charging is performed by at least an amount corresponding to the capacitance C11 of the first hydrogen-absorbing alloy, charging of the second hydrogen-absorbing alloy starts. Thus, the negative electrode potential in the charging curve L21 is the same as the negative electrode potential in the charging curve L20.

Among the two lower discharging curves shown in FIG. 7, the charging curve L31 shown by the solid line is based on a negative electrode that uses the hydrogen-absorbing alloy of the present embodiment, and the negative electrode discharging curve L30 shown by the broken line is based on a negative electrode that uses only the second hydrogen-absorbing alloy. When the negative electrode SOC is high, under the condition that the SOC is the same, the potential at the negative electrode of the present embodiment (discharging curve L31) is substantially the same as the potential at the negative electrode that uses only the second hydrogen-absorbing alloy (discharging curve L30). That is, in the initial discharging state” the dehydrogenation of the second hydrogen-absorbing alloy advances first. When discharging is performed by at least an amount corresponding to the capacitance C12 of the second hydrogen-absorbing alloy, discharging of the first hydrogen-absorbing alloy starts. Thus, when the negative electrode SOC is low, under the condition that the negative electrode SOC is the same, the potential at the negative electrode of the present embodiment (discharging curve L31) is higher (absolute value is lower) than the potential at the negative electrode formed by only the second hydrogen-absorbing alloy (discharging curve).

In this manner, when the ratio of the first hydrogen-absorbing alloy at the negative electrode is as described above, the first hydrogen-absorbing alloy that easily pulverizes is not directly involved with the charging reaction and the discharging reaction. Thus, hydrogenation and dehydrogenation of the first hydrogen-absorbing alloy may be reduced as long as the battery 10 is controlled so that the SOC of the battery 10 is within the SOC control range. Accordingly, when using the battery 10, corrosion may be hindered in the first hydrogen-absorbing alloy. Further, the second hydrogen-absorbing alloy has a low pulverization capacity and resists pulverization during charging and discharging.

Before the battery 10 is shipped from the factory, an initial activation process is performed by repeating charging and discharging ten times. Here, charging is performed until the positive electrode SOC reaches “100%,” and discharging is performed until the negative electrode capacitance reaches the capacitance that allows for pulverization of the first hydrogen-absorbing alloy. The phrase “negative electrode capacitance reaches the capacitance that allows for pulverization of the first hydrogen-absorbing alloy” refers to a condition in which the negative electrode no longer has a charged portion (hydrogenated portion), that is, the capacitance is less than the capacitance C11 of the first hydrogen-absorbing alloy and is “0” or greater. This process pulverizes the first hydrogen-absorbing alloy before the battery 10 is shipped from the factory. When the battery 10 is used as a power supply for the motor, the pulverized condition obtained in the initial activation process is substantially maintained. The first hydrogen-absorbing alloy is pulverized more easily than the second hydrogen-absorbing alloy. Thus, by pulverizing the first hydrogen-absorbing alloy in advance, the exposed area of the highly conductive metal can be increased. This lowers the internal resistance of the negative electrode and improves the output characteristics of battery 10.

Referring to FIG. 6B, when the ratio of the first hydrogen-absorbing alloy relative to the entire hydrogen-absorbing alloy is less than the ratio of the discharge reserve C2 relative to the negative capacitance C_{N} (C²/C_{N}), the capacitance balance of the battery cells 100 in each battery module 11 may be disturbed and thus lowering the discharge reserve. Nevertheless, the first hydrogen-absorbing alloy would not be involved with the charging reaction and the discharging reaction or otherwise include only a small portion involved with the charging reaction and the discharging reaction.

It has been confirmed that the output characteristics of the battery 10 are improved when the difference in the hydrogen equilibrium dissociation pressure between the first and second hydrogen-absorbing alloys at a temperature of 45° C. is 0.01 MPa or greater.

Further, in a nickel-metal hydride battery, it is known that the slight amount of hydrogen released from the hydrogen-absorbing alloy permeates the case 110 and continues to leak out. Such a leakage is apt to occurring especially when a resin case is used. In this manner, when hydrogen leaks out, hydrogen is discharged from the hydrogen-absorbing alloy in accordance with the hydrogen leakage amount to keep the partial pressure of the case 110 in equilibrium. This reduces the discharge reserve C2 of the negative electrode C2 and may ultimately eliminate the discharge reserve C2. However, the hydrogen-absorbing alloy includes the first and second hydrogen-absorbing alloys. Thus, the first hydrogen-absorbing alloy that has a low hydrogen equilibrium dissociation pressure reduces the amount of hydrogen that permeates resin and leaks out as compared with a battery in which the negative electrode is completely formed by only the second hydrogen-absorbing alloy. Accordingly, the duration of the battery 10 may be prolonged by forming the negative electrode with the mixture of the first and second adsorption alloys.

The above embodiment has the advantages described below.

(1) The negative electrode includes the first hydrogen-absorbing alloy, which has a low hydrogen equilibrium dissociation pressure and a high pulverization capacity, and the second hydrogen-absorbing alloy, which has a high hydrogen equilibrium dissociation pressure and a low pulverization capacity. The ratio of the first hydrogen-absorbing alloy is less than the ratio (C4/C_{N}) obtained by adding the ratio of the discharge reserve C2 relative to the negative electrode capacitance C_{N} (C2/C_{N}) and the ratio of the capacitance C3, which corresponds to the predetermined lower limit value that is an SOC of 0% or greater at the positive electrode, relative to the negative electrode capacitance C_{N} (C3/C_{N}). That is, the negative electrode capacitance C_{N} includes the electrode main body capacitance C5 and the discharge reserve C2, which is the capacitance added to the negative main body capacitance. The ratio of the first hydrogen-absorbing alloy is less than the ratio (C4/C_{N}) obtained by adding the ratio of the discharge reserve C2 relative to the negative electrode capacitance C_{N} (C²/C_{N}) and the ratio of the capacitance C3, which corresponds to the lower limit value of the SOC at the positive electrode 111 in the negative electrode main body capacitance C, relative to the negative electrode capacitance C_{N} (C³/C_{N}). Thus, by controlling the battery 10 so that the SOC of the battery 10 is within the SOC control range, the first hydrogen-absorbing alloy does not become directly involved with the charging reaction and the discharging reaction.

This allows only the second hydrogen-absorbing alloy, which has a low pulverization capacity, to be directly involved with the charging reaction and the discharging reaction and hinders pulverization of the first hydrogen-absorbing alloy, which has a high pulverization capacity. This reduces corrosion of the entire hydrogen-absorbing alloy. Further, in the manufacturing process, by pulverizing the first hydrogen-absorbing alloy in advance through the initial activation process, when the battery 10 is used as a power supply, the exposed area of the highly conductive metal is increased in the negative electrode. Further, the negative electrode remains in the same condition during the period the charging reaction and the discharging reaction are repeated. This reduces corrosion of the hydrogen-absorbing alloy and improves the output characteristics of the battery 10. Accordingly, the output characteristics and the corrosion resistance may both be improved.

(2) The ratio of the first hydrogen-absorbing alloy relative to the hydrogen-absorbing alloy is greater than or equal to the ratio of the charge reserve C2. This increases the exposed area of the highly conductive metal compared to a battery in which the ratio of the first hydrogen-absorbing alloy is less than the ratio of the discharge reserve C2. Thus, the output characteristics of the battery 10 may be improved.

(3) The ratio of the first hydrogen-absorbing alloy relative to the entire hydrogen-absorbing alloy is less than the ratio of the discharge reserve C2 relative to the negative electrode capacitance C_{N}. When the capacitance balance between the battery cells 100 is disturbed, the discharge reserve C2 of each battery cell 100 may be reduced. Nevertheless, the first hydrogen-absorbing alloy would not be involved with the charging reaction and the discharging reaction or otherwise include only a small portion involved with the charging reaction and the discharging reaction. Thus, the reduction in the pulverization of the first hydrogen-absorbing alloy improves the corrosion resistance.

(4) The ratio of the first hydrogen-absorbing alloy relative to the entire hydrogen-absorbing alloy is less than the ratio obtained by adding the ratio of the discharge reserve C2 relative to the negative capacitance (C2/C_{N}) and the ratio of the capacitance that is 0% or greater and less than 40% in SOC of the positive electrode. Thus, when the battery 10 is used as the power supply for a hybrid vehicle, the ratio of the first hydrogen-absorbing alloy may be set so as not to be directly involved with the charging reaction and the discharging reaction.

(5) The difference in the hydrogen equilibrium dissociation pressure between the first and second hydrogen-absorbing alloys is 0.01 MPa or greater. This produces a proper potential difference when charging is started between the potential at the first hydrogen-absorbing alloy and the potential at the second hydrogen-absorbing alloy. Thus, as long as charging and discharging is controlled so that the SOC of the battery 10 is within the SOC control range, the first hydrogen-absorbing alloy is not directly involved with the charging reaction and the discharging reaction.

(6) The resin case 110 accommodates the negative electrode that includes the first hydrogen-absorbing alloy, which has a low hydrogen equilibrium dissociation pressure, and the second hydrogen-absorbing alloy, which has a high hydrogen equilibrium dissociation pressure. When the battery 10 is controlled so that the SOC of the battery 10 is within the SOC control range, the release of hydrogen from the first hydrogen-absorbing alloy is limited. This reduces the amount of hydrogen that permeates the resin and leaks out compared to when the hydrogen-absorbing alloy of the negative electrode is completely formed by only the second hydrogen-absorbing alloy.

Example 1 and comparative example 1 will now be described. The example does not limit the present invention.

### Example 1

First, a mixture of rare earth elements such as La, Ce, praseodymium (Pr), neodymium (Nd), and samarium (Sm), more particularly, mischmetal, which is an alloy of lanthanides, was prepared. Then, a raw material composition was prepared by mixing the mischmetal with Ni, Co, Mn, and Al at a predetermined composition. Melt extraction was performed to melt the prepared raw material composition and solidify the melted raw material composition at a cooling rate of 1000° C./sec to form the hydrogen-absorbing alloy. In this case, the rapid quenching of the melted raw material composition forms the hydrogen-absorbing alloy with small variations in the distribution of composition components. Further, the weight ratio of Al and Mn relative to the entire hydrogen-absorbing alloy was adjusted to segregate the Al and Mn in a cross-section of the hydrogen-absorbing alloy and control the ratio of cross-sectional portions having a relatively high concentration. The formed hydrogen-absorbing alloy was pulverized with a ball mill into powder.

The second hydrogen-absorbing alloy was formed in the same manner as the first hydrogen alloy although the composition of the mischmetal and Ni, Co, Mn, and Al was changed. The hydrogen equilibrium dissociation pressure of the second hydrogen-absorbing alloy at 45° C. was higher than that of the first hydrogen-absorbing alloy, and the difference was 0.036 MPa. The first hydrogen-absorbing alloy has a higher magnetic susceptibility, which was measured by a VSM manufactured by Toei Industry Co., Ltd. The ratio of the first hydrogen-absorbing alloy relative to the hydrogen-absorbing alloy was 30 percent by mass.

The hydrogen-absorbing alloy powder was immersed in an alkaline solution and agitated. Then, the hydrogen-absorbing alloy powder was washed with water and dried. A thickening agent such as carboxymethyl cellulose and a binding agent such as styrene-butadiene copolymer was added to the dried hydrogen-absorbing alloy powder and kneaded to form a paste. The paste was applied to a punching metal. Then, the punching metal was dried, rolled, and cut to form a negative electrode plate.

A positive electrode plate was formed by applying an active material paste, the main component of which is nickel hydroxide, to a foam nickel base material and then drying, rolling, and cutting the base material. Positive electrode plates and negative electrode plates were alternately stacked with separators arranged in between. The separators are formed from a non-woven fabric of an alkali resistant resin. The stacked structure was then accommodated in a battery container together with an alkaline electrolyte, the main component of which was potassium hydroxide (KOH), to form a battery cell that is a nickel-metal hydride battery.

### Comparative Example 1

A battery cell was formed in the same manner as the example except in that the negative electrode was formed from only the second hydrogen-absorbing alloy of the example.

The evaluation of the battery cell of example 1 and the battery cell of comparative example 1 is as follows.

Measurement of Initial Internal Resistance Relative to Direct Current (DC-IR)

Two battery cells of example 1 and two battery cells of comparative example 1 were charged under normal temperatures until the SOC reached 60% in each battery cell. Then, for a single battery cell of example 1 and a single battery cell of comparative example 1, based on the voltage drop (ΔV) when discharging the nickel-metal hydride battery for five seconds at a fixed current value under the temperature of 25° C., the direct current internal resistance (DC-IR) of the nickel-metal hydride battery was calculated from “ΔV/current value.”

Further, the single battery cell of example 1 and the single battery cell of comparative example 1, which were charged to the SOC of 60%, were each cooled to −30° C. Then, the direct current internal resistance was calculated in the same manner as the temperature condition of 25° C. For each temperature condition, the direct current internal resistance of the battery cell of example 1 was subtracted from the direct current internal resistance of the battery cell of comparative example 1, and the difference AR was divided by the direct current internal resistance of comparative example 1 to obtain a percentage that was added to “100%.” The results are shown in the chart of FIG. 8. In the chart of FIG. 8, 100% or greater indicates that the direct current internal resistance of example 1 is lower than that of comparative example 1.

Measurement of High-Rate Internal Pressure after 250 Endurance Test Cycles

In the SOC range of 20% or greater to 80% or less, one cycle of charging and discharging were performed at 20 A in the battery cells of example 1 and comparative example 1. This endurance test was conducted for 250 cycles. Then, the internal pressure of each battery cell was measured. The internal pressure of the battery cell of example 1 was subtracted from the internal pressure of the battery cell of comparative example 1, and the difference AP was divided by the internal pressure of comparative example 1 to obtain a percentage that was added to “100%.” The results are shown in the chart of FIG. 8. In the chart of FIG. 8, 100% or greater indicates that the internal pressure of example 1 is lower than that of comparative example 1.

Measurement of Internal Resistance (DC-IR) after 250 Endurance Test Cycles

For two battery cells of example 1 and two battery cells of comparative example 1, the internal resistance was measured for each battery cell after 250 endurance test cycles. There were two temperature conditions, 25° C. and minus 30° C. The measurement of the internal resistance was performed in the same manner as the initial internal resistance.

For each temperature condition, the direct current internal resistance of the battery cell of example 1 that has undergone the endurance test at 25° C. was subtracted from the direct current internal resistance of the battery cell of comparative example 1, and the difference ΔR was divided by the direct current internal resistance of comparative example 1 to obtain a percentage that was added to “100%.” The results are shown in the chart of FIG. 8. In the chart of FIG. 8, 100% or greater indicates that the direct current internal resistance of example 1 is lower than that of comparative example 1.

From the evaluation results shown in FIG. 8, in the initial stage and after the endurance test, it may be understood that the output characteristics of the battery cell in example 1 is improved from the output characteristics of the battery cell in comparative example 1. Further, it may be understood that the internal pressure of the battery in example 1 is lower than the internal pressure of the battery in comparative example 1.

It should be apparent to those skilled in the art that the present invention may be embodied in many other specific forms without departing from the spirit or scope of the invention. Particularly, it should be understood that the present invention may be embodied in the following forms.

The hydrogen-absorbing alloy of the negative electrode compound may be formed by three or more types of hydrogen-absorbing alloys. In this case, the second hydrogen-absorbing alloy may include at least one type of hydrogen-absorbing alloy having a hydrogen equilibrium dissociation pressure allowing for direct involvement of charging and discharging when the battery is used as a power supply. Further, at least one of the first hydrogen-absorbing alloys has a lower hydrogen equilibrium dissociation pressure than the one of the second hydrogen-absorbing alloy having the lowest hydrogen equilibrium dissociation pressure. Moreover, at least one of the first hydrogen-absorbing alloys has a higher pulverization capacity than the second hydrogen-absorbing alloys.

The battery module 11 includes six battery containers. However, the battery module 11 may include any other number of battery containers with the number being two or greater.

In the above embodiment, the battery 10 is applied to a battery assembly including the battery modules 11. The battery 10 may also be applied to a single battery module 11 or a battery cell.

In the above embodiment, the SOC calculation unit 51 calculates the state of charge (SOC) of the battery 10 as a charging percentage. Instead, the state of charge of the battery 10 may be a charging amount. The charging amount and charging percentage are usually transformable to each other.

The initial activation process of the battery 10 repetitively performs charging, until the SOC of the positive electrode reaches “100%,” and discharging, until the negative electrode capacitance reaches a capacitance allowing for pulverization of the first hydrogen-absorbing alloy, for ten times. However, charging and discharging may be performed for any other number of times. The charging and discharging may also be performed only once. Further, in the initial activation process, the charging may be performed until the positive electrode SOC reaches a predetermined percentage that is less than or greater than “100%.”

In the above embodiment, “the lower limit value of the positive electrode SOC” used to determine the ratio of the first hydrogen-absorbing alloy is 40% but may be changed in accordance with the SOC control range or the like of a hybrid vehicle.

In the above embodiment, “the lower limit value of the positive electrode SOC” used to determine the ratio of the first hydrogen-absorbing alloy is the lower limit value of the state of charge when using the battery 10 as a power supply. In addition, “the lower limit value of the positive electrode SOC” may be a value including a margin added to the lower limit value of the state of charge when using the battery 10 as a power supply.

In the above embodiment, the battery 10 is a power supply for a motor installed in a hybrid vehicle but may be a power supply for a different device installed in a hybrid vehicle or any other type of vehicle. Further, the battery does not necessarily have to be used as a power supply for a vehicle and may be used as, for example, a stationary power supply. When used as a stationary power supply, the SOC control range is set to be greater than the SOC control range set when used as a power supply for a motor. Accordingly, the ratio of the first hydrogen-absorbing alloy need only be set in accordance with the SOC control range.

The lower limit value of the SOC control range may be “0%.” In this case, the ratio of the first hydrogen-absorbing alloy is less than the ratio of the discharge reserve C2 for the negative electrode capacitance.

The battery 10 may be used as a power supply for a motor installed in an electric vehicle.

The present examples and embodiments are to be considered as illustrative and not restrictive, and the invention is not to be limited to the details given herein, but may be modified within the scope and equivalence of the appended claims.

1. A nickel-metal hydride battery comprising:
a positive electrode; and
a negative electrode including a hydrogen-absorbing alloy that includes a first hydrogen-absorbing alloy and a second hydrogen-absorbing alloy, wherein
the negative electrode has a capacitance including a negative electrode main body capacitance, which corresponds to a capacitance of the positive electrode, and a discharge reserve, which is a capacitance added to the negative electrode main body capacitance;
the first hydrogen-absorbing alloy has a lower hydrogen equilibrium dissociation pressure than the second hydrogen-absorbing alloy and a higher pulverization capacity, which indicates how easy pulverization occurs, than the second hydrogen-absorbing alloy;
the positive electrode has a state of charge with a lower limit value of 0% or greater; and
a ratio of the first hydrogen-absorbing alloy relative to the entire hydrogen-absorbing alloy is less than a ratio obtained by adding a ratio of the discharge reserve relative to the capacitance of the negative electrode and a ratio of a capacitance corresponding to the lower limit value of the state of charge of the positive electrode in the negative electrode main body capacitance relative to the capacitance of the negative electrode.

2. The nickel-metal hydride battery according to claim 1, wherein the ratio of the first hydrogen-absorbing alloy relative to the entire hydrogen-absorbing alloy is greater than or equal to the ratio of the discharge reserve relative to the capacitance of the negative electrode.

3. The nickel-metal hydride battery according to claim 1, wherein the ratio of the first hydrogen-absorbing alloy relative to the entire hydrogen-absorbing alloy is less than the ratio of a capacitance of the discharge reserve relative to the capacitance of the negative electrode.

4. The nickel-metal hydride battery according to claim 1, wherein the lower limit value is the lower limit value of the state of charge of the positive electrode when the nickel-metal hydride battery is used as a power supply.

5. The nickel-metal hydride battery according to claim 1, wherein the lower limit value is 40%.

6. The nickel-metal hydride battery according to claim 1, wherein a difference in the hydrogen equilibrium dissociation pressure between the second hydrogen-absorbing alloy and the first hydrogen-absorbing alloy under a temperature of 45° C. is 0.01 MPa or greater.

7. The nickel-metal hydride battery according to claim 1, further comprising a resin case that accommodates the positive electrode and the negative electrode.
